(19) United States
(12) Patent Application Publication
(10) Pub. No.: US 2024/0267938 A1
(43) Pub. Date: Aug. 8, 2024

(54) COMMUNICATION METHOD

(71) Applicant: KYOCERA Corporation, Kyoto (JP)

(72) Inventor: Masato FUJISHIRO, Yokohama-shi, Kanagawa (JP)

(73) Assignee: KYOCERA Corporation, Kyoto (JP)

(21) Appl. No.: 18/633,912

(22) Filed: Apr. 12, 2024

Related U.S. Application Data
(63) Continuation of application No. PCT/JP2022/038111, filed on Oct. 12, 2022.
(60) Provisional application No. 63/255,563, filed on Oct. 14, 2021.

(51) Int. Cl. H04W 72/30; H04W 76/11

(52) U.S. Cl. CPC H04W 72/30; H04W 76/11

(57) ABSTRACT

In a first aspect, a communication method is used in a mobile communication system for providing a multicast and broadcast service (MBS), the communication method including transmitting, by a first base station, a paging message to a second base station over an inter-base station interface, the paging message requesting paging of a user equipment having joined a multicast session and including an MBS session identifier for identifying the multicast session.

### RELATED APPLICATIONS

The present application is a continuation based on PCT Application No. PCT/JP2022/038111, filed on Oct. 12, 2022, which claims the benefit of U.S. Provisional Patent Application No. 63/255563 filed on Oct. 14, 2021. The content of which is incorporated by reference herein in their entirety.

### TECHNICAL FIELD

The present disclosure relates to a communication method used in a mobile communication system.

### BACKGROUND OF INVENTION

In 3rd Generation Partnership Project (3GPP) standards, technical specifications of New Radio (NR) being radio access technology of the fifth generation (5G) have been defined. NR has features such as high speed, large capacity, high reliability, and low latency, in comparison to Long Term Evolution (LTE) being radio access technology of the fourth generation (4G). In 3GPP, there have been discussions for establishing technical specifications of multicast and broadcast services (MBS) of 5G/NR (for example, see Non-Patent Document 1).

### CITATION LIST

### Non-Patent Literature

Non-Patent Document 1: 3GPP Contribution: RP-201038, “WID revision: NR Multicast and Broadcast Services”

### SUMMARY

5G/NR multicast and broadcast services are desired to provide enhanced services compared to 4G/LTE multicast and broadcast services.

In view of this, the present disclosure provides a communication method for enabling implementation of enhanced multicast and broadcast services.

In a first aspect, a communication method is used in a mobile communication system for providing a multicast and broadcast service (MBS), the communication method including transmitting, by a first base station, a paging message to a second base station over an inter-base station interface, the paging message requesting paging of a user equipment having joined a multicast session and including an MBS session identifier for identifying the multicast session.

In a second aspect, a communication method is used in a mobile communication system for providing a multicast and broadcast service (MBS), the communication method including: transmitting, by a paging entity, a first paging message including an MBS session identifier for identifying a multicast session to be started, the paging entity generating a paging message used to page a user equipment in a radio resource control (RRC) idle state or an RRC inactive state; identifying, by the paging entity, a user equipment having joined the multicast session and having not responded to the first paging message; and transmitting, by the paging entity, a second paging message including a user equipment identifier for identifying the identified user equipment.

A communication method according to a third aspect is a communication method used in a mobile communication system for providing a multicast and broadcast service (MBS), the communication method including: setting, by a user equipment in a radio resource control (RRC) idle state or an RRC inactive state, cause information indicating a reason to transition to an RRC connected state in an RRC message used to transition to the RRC connected state; and transmitting, by the user equipment, the RRC message to a base station. The setting includes setting first cause information defined for MBS reception in the RRC message as the cause information when the reason is only the MBS reception, and setting second cause information defined for unicast communication in the RRC message as the cause information when the reason is the MBS reception and the unicast communication.

### BRIEF DESCRIPTION OF THE DRAWINGS

FIG. 1 is a diagram illustrating a configuration of a mobile communication system according to an embodiment.

FIG. 2 is a diagram illustrating a configuration of a user equipment (UE) according to an embodiment.

FIG. 3 is a diagram illustrating a configuration of a gNB (base station) according to an embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signaling (control signal).

FIG. 6 is a diagram illustrating an overview of MBS traffic delivery according to an embodiment.

FIG. 7 is a diagram illustrating delivery modes according to an embodiment.

FIG. 8 is a diagram illustrating an example of internal processing related to MBS reception of the UE according to an embodiment.

FIG. 9 is a diagram illustrating another example of internal processing related to MBS reception of the UE according to an embodiment.

FIG. 10 is a diagram illustrating an operation related to group activation notification according to an embodiment.

FIG. 11 is a diagram illustrating a first operation example according to a first embodiment.

FIG. 12 is a diagram illustrating a second operation example according to the first embodiment.

FIG. 13 is a diagram illustrating an example of cause information according to a second embodiment.

FIG. 14 is a diagram illustrating a first operation example according to the second embodiment.

FIG. 15 is a diagram illustrating a second operation example according to the second embodiment.

### DESCRIPTION OF EMBODIMENTS

A mobile communication system according to an embodiment is described with reference to the drawings. In the description of the drawings, the same or similar parts are denoted by the same or similar reference signs.

### First Embodiment

### Configuration of Mobile Communication System

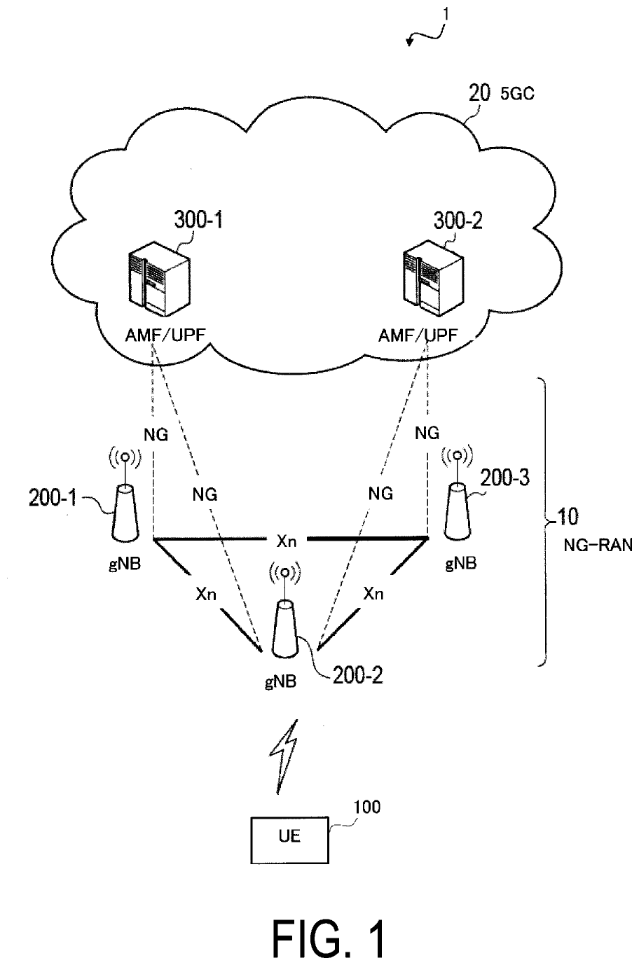

FIG. 1 is a diagram illustrating a configuration of a mobile communication system according to a first embodiment. The mobile communication system 1 complies with the 5th Generation System (5GS) of the 3GPP standard. The description below takes the 5GS as an example, but Long Term Evolution (LTE) system may be at least partially applied to the mobile communication system. A sixth generation (6G) system may be at least partially applied to the mobile communication system.

The mobile communication system 1 includes a User Equipment (UE) 100, a 5G radio access network (Next Generation Radio Access Network (NG-RAN)) 10, and a 5G Core Network (5GC) 20. The NG-RAN 10 maybe hereinafter simply referred to as a RAN 10. The 5GC 20 maybe simply referred to as a core network (CN) 20.

The UE 100 is a mobile wireless communication apparatus. The UE 100 may be any apparatus as long as the UE 100 is used by a user. Examples of the UE 100 include a mobile phone terminal (including a smartphone) or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as one “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

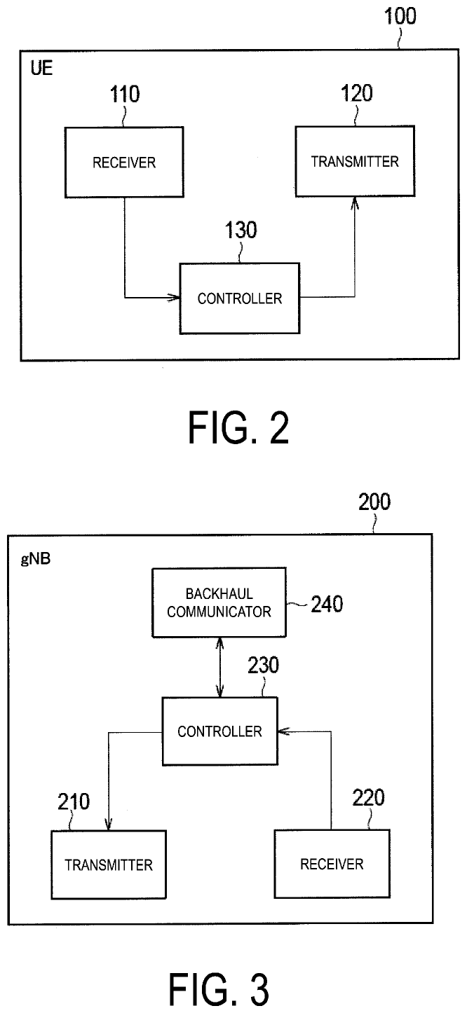

FIG. 2 is a diagram illustrating a configuration of the UE 100 (user equipment) according to the first embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processes in the UE 100. Such processes include processes of respective layers to be described later. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

FIG. 3 is a diagram illustrating a configuration of the gNB 200 (base station) according to the first embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processes in the gNB 200. Such processes include processes of respective layers to be described later. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via an Xn interface between base stations. The backhaul communicator 240 is connected to the AMF/UPF 300 via a NG interface between a base station and the core network. Note that the gNB 200 may include a Central Unit (CU) and a Distributed Unit (DU) (i.e., functions are divided), and the two units may be connected via an F1 interface, which is a fronthaul interface.

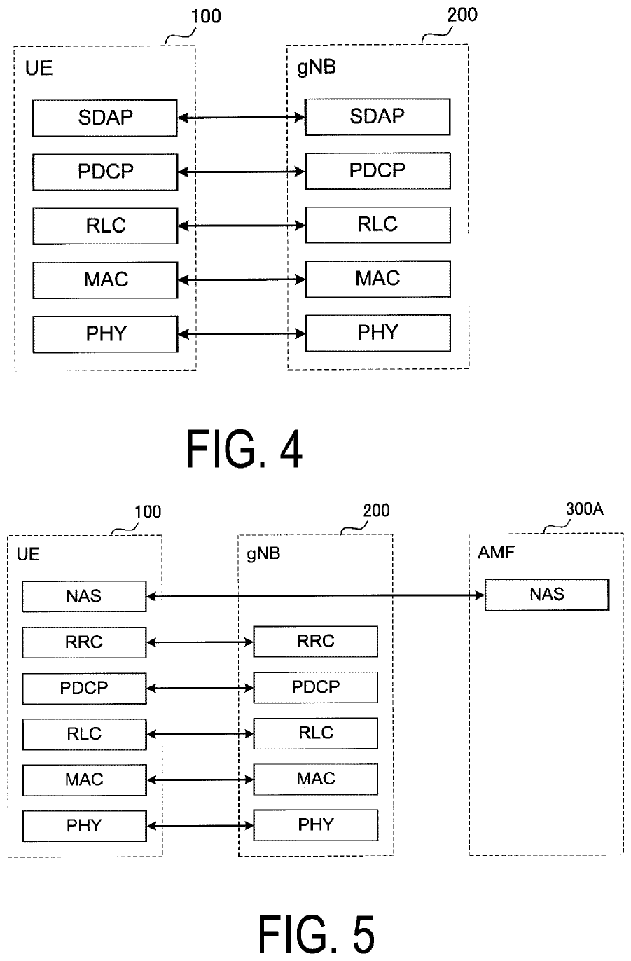

FIG. 4 is a diagram illustrating a configuration of a protocol stack of a radio interface of a user plane handling data.

A radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE 100. The DCI transmitted from the gNB 200 is appended with CRC parity bits scrambled by the RNTI.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler determines transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QoS) control performed by a core network and a radio bearer as the unit of QoS control performed by an Access Stratum (AS). Note that, when the RAN is connected to the EPC, the SDAP need not be provided.

FIG. 5 is a diagram illustrating a configuration of a protocol stack of a radio interface of a control plane handling signaling (a control signal).

The protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS layer which is positioned upper than the RRC layer performs session management, mobility management, and the like. NAS signaling is transmitted between the NAS layer of the UE 100 and the NAS layer of an AMF 300A. Note that the UE 100 includes an application layer other than the protocol of the radio interface. A layer lower than the NAS layer is referred to as an AS layer.

### Overview of MBS

An overview of the MBS according to the first embodiment will be described. The MBS is a service in which the NG-RAN 10 can provide broadcast or multicast, i.e., Point To Multipoint (PTM) data transmission to the UE 100. Assumed use cases (service types) of the MBS include public safety communication, mission critical communication, Vehicle to Everything (V2X) communication, IPv4 or IPv6 multicast delivery, Internet Protocol TeleVision (IPTV), group communication, and software delivery.

A broadcast service provides a service to every UE 100 within a particular service area for an application not requiring highly reliable QoS. An MBS session used for the broadcast service is referred to as a broadcast session.

A multicast service provides a service not to every UE 100, but to a group of UEs 100 having joined the multicast service (multicast session). An MBS session used for the multicast service is referred to as a multicast session. The multicast service can provide the same content to the group of UEs 100 through a method with higher radio efficiency than the broadcast service.

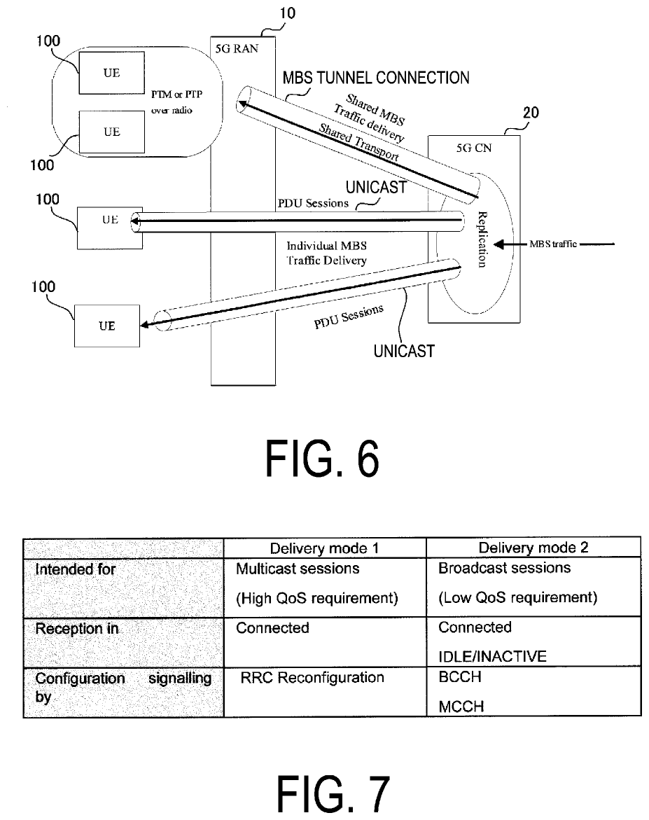

FIG. 6 is a diagram illustrating an overview of MBS traffic delivery according to the first embodiment.

MBS traffic (MBS data) is delivered from a single data source (application service provider) to a plurality of UEs. The 5G CN (5GC) 20, which is a 5G core network, receives the MBS data from the application service provider and performs Replication of the MBS data to deliver the resultant.

From the perspective of the 5GC 20, two multicast delivery methods are possible: 5GC Shared MBS Traffic delivery and 5GC Individual MBS Traffic delivery.

In the 5GC individual MBS traffic delivery method, the 5GC 20 receives a single copy of MBS data packets and delivers individual copies of these MBS data packets to the individual UEs 100 via PDU sessions of the individual UEs 100. Thus, one PDU session for each UE 100 needs to be associated with a multicast session.

In the 5GC shared MBS traffic delivery method, the 5GC 20 receives a single copy of MBS data packets and delivers the single copy of the MBS packets to a RAN node (i.e., the gNB 200). The gNB 200 receives the MBS data packets via MBS tunnel connection, and delivers those to one or more UEs 100.

From the perspective of the RAN (5G RAN) 10, two delivery methods are possible for radio transmission of the MBS data in the 5GC shared MBS traffic delivery method: a Point-to-Point (PTP) delivery method and a Point-to-Multipoint (PTM) delivery method. PTP means unicast, and PTM means multicast and broadcast.

In the PTP delivery method, the gNB 200 wirelessly delivers the individual copies of the MBS data packets to the individual UEs 100. On the other hand, in the PTM delivery method, the gNB 200 wirelessly delivers the single copy of the MBS data packets to a group of the UEs 100. The gNB 200 can dynamically determine whether to use the PTM or PTP delivery method as a method for delivering the MBS data to one UE 100.

The PTP and PTM delivery methods are mainly related to the user plane. Modes for controlling the MBS data delivery include two delivery modes: a first delivery mode and a second delivery mode.

FIG. 7 is a diagram illustrating the delivery modes according to the first embodiment.

The first delivery mode (Delivery mode 1 (DM1)) is a delivery mode that can be used by the UE 100 in the RRC connected state, and is a delivery mode for high QoS requirements. The first delivery mode is used for multicast sessions among MBS sessions. Note that the first delivery mode may be used for broadcast sessions. The first delivery mode may be available to the UE 100 in the RRC idle state or the RRC inactive state.

MBS reception configuration in the first delivery mode is performed through UE-dedicated signaling. For example, the MBS reception configuration in the first delivery mode is performed through an RRC Reconfiguration message (or an RRC Release message), which is an RRC message unicast from the gNB 200 to the UE 100.

The MBS reception configuration includes MBS traffic channel configuration information (hereinafter referred to as “MTCH configuration information”) about configuration of an MBS traffic channel transmitting MBS data. The MTCH configuration information includes MBS session information (including an MBS session identifier described below) relating to an MBS session and scheduling information of an MBS traffic channel corresponding to the MBS session. The scheduling information of an MBS traffic channel may include discontinuous reception (DRX) configuration of the MBS traffic channel. The discontinuous reception configuration may include at least one parameter of a timer value (On Duration Timer) for defining an on-period (On Duration: reception period), a timer value (Inactivity Timer) for extending the on-period, a scheduling interval or a DRX cycle (Scheduling Period, DRX Cycle), an offset value (Start Offset, DRX Cycle Offset) of a start subframe for scheduling or a DRX cycle, a start delay slot value (Slot Offset) of an on-period timer, a timer value (Retransmission Timer) for defining a maximum time until retransmission, and a timer value (HARQ RTT Timer) for defining a minimum interval until DL assignment of HARQ retransmission.

Note that the MBS traffic channel is a type of logical channel and may be referred to as an MTCH. The MBS traffic channel is mapped to a downlink shared channel (Down Link-Shared CHannel (DL-SCH)) being a type of transport channel.

The second delivery mode (Delivery mode 2 (DM2)) is a delivery mode that can be used not only by the UE 100 in the RRC connected state, but also by the UE 100 in the RRC idle state or the RRC inactive state, and is a delivery mode for low QoS requirements. The second delivery mode is used for broadcast sessions among MBS sessions. However, the second delivery mode may also be applicable to multicast sessions.

An MBS reception configuration in the second delivery mode is performed through broadcast signaling. For example, the MBS reception configuration in the second delivery mode is performed using a logical channel transmitted from the gNB 200 to the UE 100 through broadcast, for example, a broadcast control channel (BCCH) and/or a multicast control channel (MCCH). The UE 100 can receive the BCCH and the MCCH, using a dedicated RNTI defined in technical specifications in advance, for example. The RNTI for BCCH reception may be an SI-RNTI, and the RNTI for MCCH reception may be an MCCH-RNTI.

In the second delivery mode, the UE 100 may receive the MBS data in the following three procedures. Firstly, the UE 100 receives MCCH configuration information on an SIB (MBS SIB) transmitted from the gNB 200 on the BCCH. Secondly, the UE 100 receives the MCCH from the gNB 200, based on the MCCH configuration information. On the MCCH, MTCH configuration information is transmitted. Thirdly, the UE 100 receives the MTCH (MBS data), based on the MTCH configuration information. The MTCH configuration information and/or the MCCH configuration information may be hereinafter referred to as the MBS reception configuration.

In the first delivery mode and the second delivery mode, the UE 100 may receive the MTCH, using a group RNTI (G-RNTI) assigned from the gNB 200. The G-RNTI corresponds to an RNTI for MTCH reception. The G-RNTI may be included in the MBS reception configuration (MTCH configuration information).

The network can provide different MBS services for different MBS sessions. The MBS session is identified by at least one selected from the group consisting of a Temporary Mobile Group Identity (TMGI), a source-specific IP multicast address (which consists of a source unicast IP address, such as an application function and an application server, and an IP multicast address indicating a destination address), a session identifier, and a G-RNTI. At least one selected from the group consisting of the TMGI, the source specific IP multicast address, and the session identifier is referred to as an MBS session identifier. The TMGI, the source-specific IP multicast address, the session identifier, and the G-RNTI are collectively referred to as MBS session information.

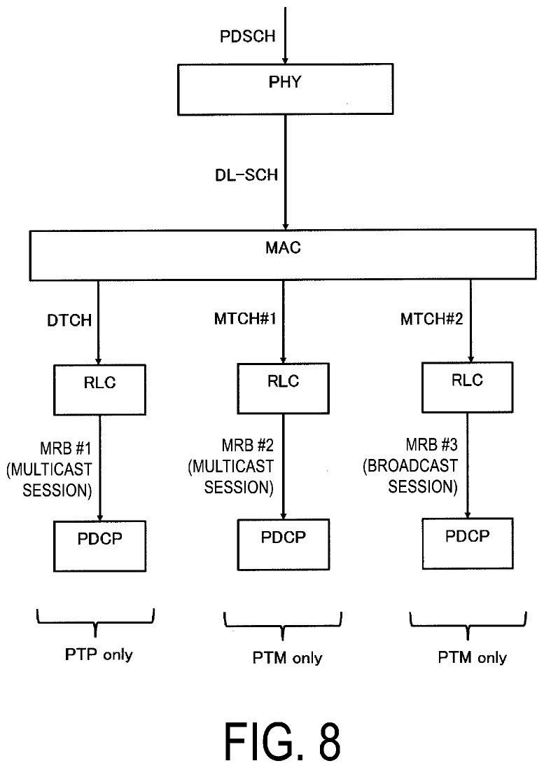

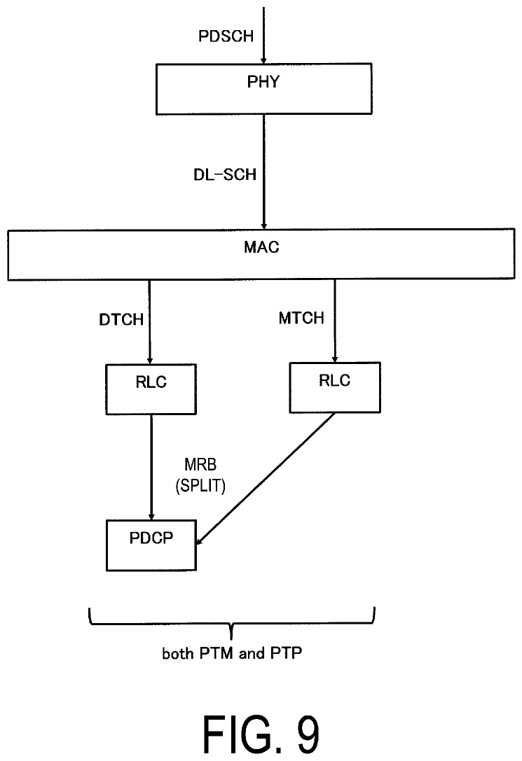

FIG. 8 is a diagram illustrating an example of internal processing related to MBS reception of the UE 100 according to the first embodiment. FIG. 9 is a diagram illustrating another example of the internal processing related to the MBS reception of the UE 100 according to the first embodiment.

One MBS radio bearer (MRB) is one radio bearer for transmitting a multicast session or a broadcast session. In other words, the MRB may be associated with a multicast session or with a broadcast session.

The MRB and the corresponding logical channel (e.g., MTCH) are configured for the UE 100 by the gNB 200 using RRC signaling. A configuration procedure for the MRB may be separated from a configuration procedure for the data radio bearer (DRB). The RRC signaling allows one MRB to be configured with “PTM only”, “PTP only”, or “both PTM and PTP”. The type of the MRB may be changed by the RRC signaling.

FIG. 8 illustrates an example in which an MRB #1 is associated with a multicast session and a dedicated traffic channel (DTCH), an MRB #2 is associated with a multicast session and an MTCH #1, and an MRB #3 is associated with a broadcast session and an MTCH #2. In other words, the MRB #1 is an MRB of PTP only, the MRB #2 is an MRB of PTM only, and the MRB #3 is an MRB of PTM only. Note that the DTCH is scheduled using a cell RNTI (C-RNTI). The MTCH is scheduled using the G-RNTI.

The PHY layer of the UE 100 processes user data (received data) received on the PDSCH, which is one of physical channels, and routes the processed user data to the downlink shared channel (DL-SCH), which is one of transport channels. The MAC layer (MAC entity) of the UE 100 processes the data received on the DL-SCH and routes the received data to a corresponding logical channel (corresponding RLC entity) based on a logical channel identifier (LCID) included in the header (MAC header) included in the received data.

FIG. 9 illustrates an example in which the MRB associated with a multicast session is associated with the DTCH and the MTCH. Specifically, one MRB is split into two legs, one of the legs is associated with the DTCH, and the other leg is associated with the MTCH. The two legs are combined together in the PDCP layer (PDCP entity). In other words, the MRB is an MRB of both PTM and PTP. Such an MRB may be referred to as a split MRB.

### Group Activation Notification

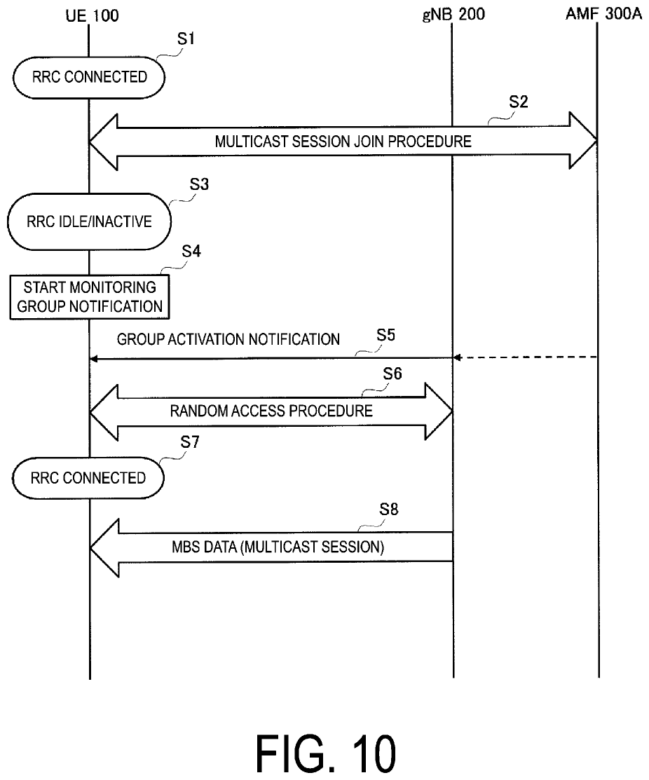

FIG. 10 is a diagram illustrating an operation related to a group activation notification according to the first embodiment. The group activation notification may be referred to as a multicast activation notification or a session activation notification.

Here, a case is mainly assumed in which the UE 100 in the RRC connected state receives MBS data (i.e., multicast data) multicasted from the gNB 200 in Delivery mode 1. Thus, an MBS session is assumed to be a multicast session. A multicast session may be mapped to a PTM leg or a PTM bearer (MRB). The multicast session may be mapped to a PTP leg, a PTP bearer, or a split MRB. The MBS traffic channel (MTCH) or the dedicated traffic channel (DTCH) is used for multicast data transmission from the gNB 200 to the UE 100.

After joining the multicast session, the UE 100 transitions to the RRC idle state or the RRC inactive state and waits for start of the multicast session. The UE 100 in the RRC idle state or the RRC inactive state receives a group activation notification that indicates start (activation) of the multicast session which the UE 100 has joined and that is transmitted from the network to a group to which the UE 100 belongs. The group activation notification is assumed to be a type of paging message. The UE 100 transitions to the RRC connected state upon receipt of the group activation notification and receives multicast data of the multicast session from the gNB 200.

Hereinafter, the RAN 10 (gNB 200) and the CN 20 (in particular, AMF 300A) are collectively referred to as a “network” as appropriate. The AMF 300A is an example of a core network (CN) apparatus. The AMF 300A manages the MBS session (multicast session) in cooperation with a session management apparatus. The session management apparatus may be an (MB-)SMF.

In Step S1, the UE 100 is in the RRC connected state. It is assumed that the UE 100 is interested in a certain multicast session (hereinafter referred to as a “target multicast session”). “Being interested in a multicast session” means that an upper layer of the UE 100 requests or desires to receive a multicast session. The upper layer includes the NAS layer. The upper layer may further include an application.

In Step S2, the UE 100 (NAS entity) performs, on the network, a multicast session join procedure for joining the target multicast session. For example, the UE 100 has joined the target multicast session by transmitting a first NAS message requesting joining the target multicast session to an AMF 300A and receiving a second NAS message approving joining the target multicast session from the AMF 300A. For example, the first NAS message may be a PDU Session Modification Request, and the message may include an MBS session identifier and information for the join request. When the MRB configuration from the gNB 200 is used to implicitly notify the approval of the first NAS message, the second NAS message may be omitted. “Join the target multicast session” means to register the UE 100 in a CN apparatus as a member of a UE group (multicast group) that receives the multicast session. The CN apparatus may authenticate the UE 100 at the time of registration. The CN apparatus may allow the UE 100 to receive the multicast session. Note that the multicast session may be joined while the multicast session is in a valid state (the multicast session is being transmitted) or in an invalid state (while the start of transmission is waited for, or transmission is interrupted).

In Step S3, the UE 100 transitions to the RRC idle state or the RRC inactive state. Specifically, the UE 100 transitions to the RRC idle state or the RRC inactive state by receiving an RRC Release message from the gNB 200. Prior to Step S3, the UE 100 may transmit, to the gNB 200, an RRC message (for example, a UE Assistance Information message) including an information element for prompting the UE 100 to transition to the RRC idle state or the RRC inactive state. The gNB 200 may determine to cause the UE 100 to transition to the RRC idle state or the RRC inactive state when the multicast session in which the UE 100 is interested is inactive.

In Step S4, the UE 100 starts monitoring a group activation notification from the gNB 200. In the first embodiment, the group activation notification may be a paging message transmitted from the AMF 300A via the gNB 200. For example, the UE 100 monitors the group activation notification on a paging occasion (PO) of a periodically configured paging frame (PF). The group activation notification may be to notify session start of the multicast session. The session start may be activation of the multicast session from an inactive state.

In Step S5, the gNB 200 transmits a group activation notification addressed to a group including the UE 100 or a group in which the UE 100 is interested. The gNB 200 may transmit the group activation notification (paging message) to the UE 100 in response to a paging request (group activation notification request) from the AMF 300A. The group activation notification includes an MBS session identifier indicating the multicast session to be started. Upon receiving the group activation notification including such an identifier, the UE 100 can recognize start of the target multicast session that the UE 100 joins. The start of the target multicast session may be activation of transmission of multicast data in the target multicast session. The start of the target multicast session may be transition to a state in which transmission of the multicast data can be started in the target multicast session.

In Step S6, the UE 100 performs a random access procedure on the gNB 200 for reception in the target multicast session.

In Step S7, the UE 100 transitions to the RRC connected state through the random access procedure.

In Step S8, the UE 100 in the RRC connected state receives multicast data of the target multicast session from the gNB 200. The gNB 200 may perform configuration for receiving the target multicast session on the UE 100 before the data reception. The configuration is, for example, an RRC Reconfiguration message including an MRB configuration.

Such a group activation notification (paging message) enables efficient paging of the UE 100 in the RRC idle state or the RRC inactive state having joined the multicast session.

### Operation of Mobile Communication System

An operation of the mobile communication system 1 according to the first embodiment will be described.

The group activation notification (paging message) described above is available only when the gNB 200 supports an MBS function. Accordingly, when existing in the cell of the gNB 200 that does not support the MBS function, the UE 100 in the RRC idle state or the RRC inactive state cannot receive the group activation notification. When the radio state of the UE 100 is temporarily poor, the UE 100 may fail to receive the group activation notification. Accordingly, in the first embodiment, using the group activation notification (paging message) and the normal paging message together enables more reliable paging of the UE 100 in the RRC idle state or the RRC inactive state having joined the multicast session.

In the first embodiment, a paging entity generates a paging message for paging a UE 100 in the RRC idle state or the RRC inactive state. Firstly, the paging entity transmits a first paging message (i.e., a group activation notification) including the MBS session identifier (e.g., a TMGI) for identifying the multicast session to be started. Secondly, the paging entity identifies a UE 100 having joined the multicast session and having not responded to the first paging message. Thirdly, the paging entity transmits a second paging message (i.e., a normal paging message) including a UE identifier (e.g., 5G-S-TMSI) for identifying the identified UE 100. For example, the paging entity transmits the second paging message only when any UE 100 having joined the multicast session has not responded to the first paging message.

This enables more reliable paging of the UE 100 in the RRC idle state or the RRC inactive state having joined the multicast session. When all UEs 100 having joined the multicast session respond to the first paging message (i.e., transition to the RRC connected state), the second paging message is not transmitted, and thus consumption of radio resources is reduced.

In the first embodiment, the paging entity may be the AMF 300A. Alternatively, the paging entity may be the gNB 200. For example, for the UE 100 in the RRC idle state, the AMF 300A may generate and transmit a paging message, but for the UE 100 in the RRC inactive state, the gNB 200 may generate and transmit a paging message.

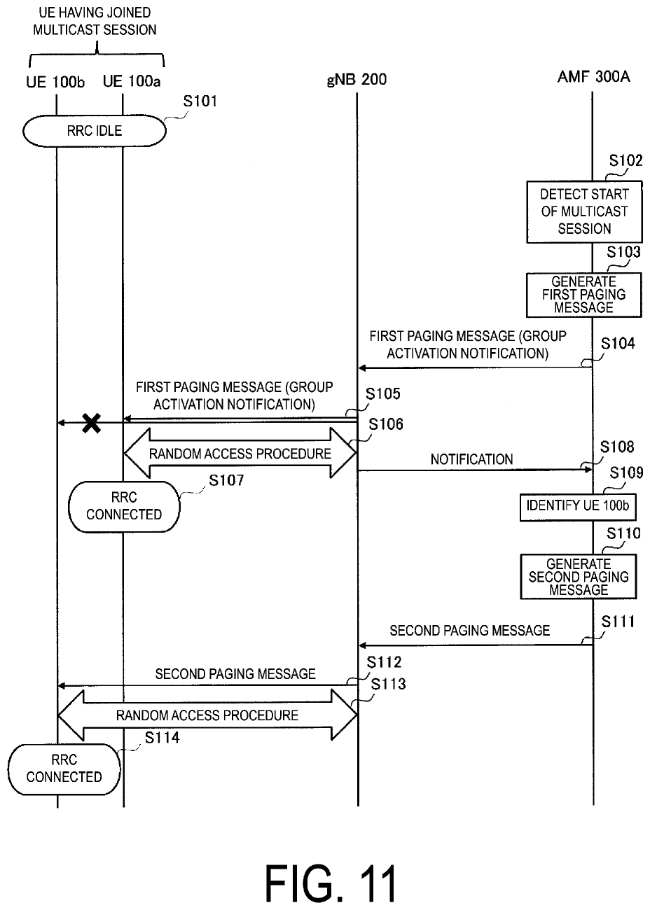

FIG. 11 is a diagram illustrating a first operation example according to the first embodiment. In the first operation example according to the first embodiment, the paging entity is assumed to be the AMF 300A.

In Step S101, each of a UE 100a and a UE 100b that have joined (Session join) a certain multicast session (hereinafter referred to as “multicast session #1”) is in the RRC idle state. Note that although each of the UE 100a and UE 100b exists in the cell of the same gNB 200, the UE 100a and UE 100b may exist in the cells of different gNBs 200.

In Step S102, the AMF 300A detects the start (activation) of the multicast session #1.

In Step S103, the AMF 300A generates a first paging message (i.e., group activation notification) including the MBS session identifier (e.g., TMGI) of the multicast session #1 to be started.

In Step S104, the AMF 300A transmits the first paging message to the gNB 200. The first paging message is transmitted on the NG interface.

In Step S105, the gNB 200 transmits the first paging message received from the AMF 300A. The first paging message may be an RRC message. Here, it is assumed that the UE 100a successfully receives the first paging message, whereas the UE 100b fails to receive the first paging message. Therefore, the UE 100b does not respond to the first paging message and does not transition to the RRC connected state.

Upon receiving the first paging message, the UE 100a judges that the multicast session #1 is to be started in response to the first paging message including the MBS session identifier of the multicast session #1 joined by the UE 100a, and determines to transition to the RRC connected state.

In Step S106, the UE 100a performs the random access procedure with the gNB 200. The details of the random access procedure will be described in a second embodiment.

In Step S107, the UE 100a transitions to the RRC connected state through the random access procedure. The UE 100a receives, from the gNB 200, an RRC reconfiguration message including MTCH configuration information for configuring the MTCH for the multicast session #1, and receives the MTCH based on the MTCH configuration information. As a result, the UE 100a receives the MBS data of the multicast session #1 on the MTCH.

In Step S108, the gNB 200 transmits, to the AMF 300A, a notification indicating that the UE 100a has transitioned to the RRC connected state in response to the first paging message. Such a notification may be an initial UE message. The notification may be a UE context resume request message.

In Step S109, the AMF 300A identifies, based on the notification from the gNB 200, the UE 100b having joined the multicast session #1 and having not responded to the first paging message. For example, the AMF 300A identifies the remaining UEs (i.e., UE 100b) other than the UE 100a having responded to the first paging message from the list of UEs having joined the multicast session #1.

In Step S110, the AMF 300A generates a second paging message (i.e., a normal paging message) including the UE identifier of the UE 100b identified in Step S109.

In Step S111, the AMF 300A transmits the second paging message to the gNB 200. The second paging message is transmitted on the NG interface.

In Step S112, the gNB 200 transmits the second paging message received from the AMF 300A. Upon receiving the second paging message, the UE 100b determines to transition to the RRC connected state in response to the second paging message including the UE identifier of the UE 100b.

In step S113, the UE 100b performs the random access procedure with the gNB 200.

In Step S114, the UE 100b transitions to the RRC connected state through the random access procedure. The UE 100b receives, from the gNB 200, an RRC reconfiguration message including MTCH configuration information for configuring the MTCH for the multicast session #1, and receives the MTCH based on the MTCH configuration information. As a result, the UE 100b receives the MBS data of the multicast session #1 on the MTCH.

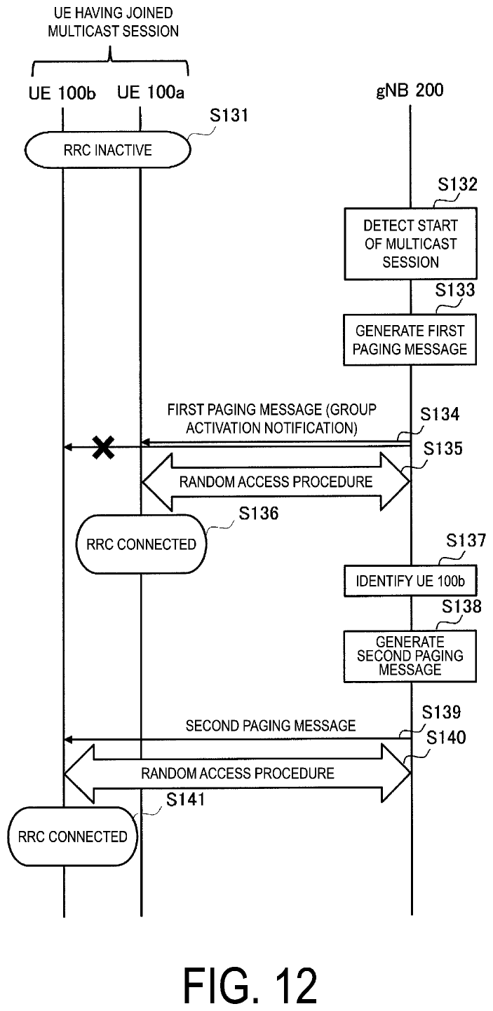

FIG. 12 is a diagram illustrating a second operation example according to the first embodiment. In the second operation example according to the first embodiment, the paging entity is assumed to be the gNB 200. Here, the difference from the operation first example according to the first embodiment will be described.

In Step S131, each of the UE 100a and the UE 100b having joined multicast session #1 (Session join) is in the RRC inactive state.

In Step S132, the gNB 200 detects the start (activation) of the multicast session #1.

In Step S133, the gNB 200 generates a first paging message (i.e., group activation notification) including the MBS session identifier (e.g., TMGI) of the multicast session #1 to be started. The first paging message may be transmitted to the neighboring gNB via the Xn interface. The Xn message may be RAN PAGING or may be a new message (e.g., RAN GROUP NOTIFICATION).

In Step S134, the gNB 200 transmits the first paging message. The first paging message is an RRC message and may also be referred to as a RAN paging message. Here, it is assumed that the UE 100a successfully receives the first paging message, whereas the UE 100b fails to receive the first paging message.

Upon receiving the first paging message, the UE 100a judges that the multicast session #1 is to be started in response to the first paging message including the MBS session identifier of the multicast session #1 joined by the UE 100a, and determines to transition to the RRC connected state.

In Step S135, the UE 100a performs the random access procedure with the gNB 200.

In Step S136, the UE 100a transitions to the RRC connected state through the random access procedure. When the random access procedure is performed in the neighboring gNB, the neighboring gNB may notify the gNB 200 via the Xn interface that the neighboring gNB has been accessed by the UE 100a. The notification may be made implicitly by a procedure of obtaining contextual information of the UE 100a from the gNB 200. Such a procedure includes a RETRIEVE UE CONTEXT REQUEST message and a RETRIEVE UE CONTEXT RESPONSE message.

In Step S137, the gNB 200 identifies the UE 100b having joined the multicast session #1 and having not responded to the first paging message.

In Step S138, the gNB 200 generates a second paging message (i.e., a normal RAN paging message) including the UE identifier of the UE 100b identified in Step S137.

In Step S139, the gNB 200 transmits the second paging message. Upon receiving the second paging message, the UE 100b determines to transition to the RRC connected state in response to the second paging message including the UE identifier of the UE 100b.

In Step S140, the UE 100b performs the random access procedure with the gNB 200.

In Step S141, the UE 100b transitions to the RRC connected state through the random access procedure.

### Second Embodiment

A second embodiment will be described mainly regarding differences from the first embodiment described above.

The UE 100 in the RRC idle state or the RRC inactive state sets cause information indicating the reason to transition to the RRC connected state in an RRC message (i.e., an RRC Setup Request message or an RRC Resume Request message) for transitioning to the RRC connected state. Such cause information may be referred to as a Cause information element (Cause IE). Note that hereinafter, the RRC message for transitioning to the RRC connected state may be referred to as a “connection request message”.

Upon receiving the connection request message, the gNB 200 judges whether to accept the connection request based on the Cause information elements included in the connection request message. For example, when a resource status (a radio resource, a hardware load, a BH link, or the like) is tight, the gNB 200 performs congestion mitigation by rejecting a connection request associated with a low-priority service.

In particular, considering a case where the MBS service is provided only by the PTM, even when the UE 100 newly starts PTM reception, increased resource consumption in the gNB 200 has a low impact. To be more specific, PTM transmission and a shared delivery tunnel have already been established for other UEs 100, and the resource consumption basically remains unchanged even with an increased number of UEs 100.

Accordingly, there is a large difference in resource consumption between acceptance of a connection request from a unicast UE 100 and acceptance of a connection request from a multicast-receiving UE 100. Here, when the gNB 200 is congested but can accept a multicast-receiving UE 100, it is inefficient to fail to recognize the situation and reject connection from the multicast-receiving UE 100.

In the second embodiment, the UE 100 in the RRC idle state or the RRC inactive state sets cause information indicating the reason to transition to the RRC connected state in an RRC message (connection request message) for transitioning to the RRC connected state, and then transmits the RRC message to the gNB 200. When the reason is only MBS reception (for example, PTM reception or multicast reception), the UE 100 sets, in the RRC message as cause information, the first cause information defined for MBS reception (PTM reception, multicast reception). On the other hand, when the reason includes both MBS reception and unicast communication (for example, uplink data transmission), the UE 100 sets, in the RRC message as cause information, second cause information defined for unicast communication.

Thus, the gNB 200 can identify a connection request intended only for PTM reception (in particular, multicast reception), and can appropriately accept a connection request intended only for PTM reception (in particular, multicast reception). The gNB 200 can appropriately reject a connection request intended for PTM reception (in particular, multicast reception) and unicast communication (in particular, uplink data transmission) according to the resource status.

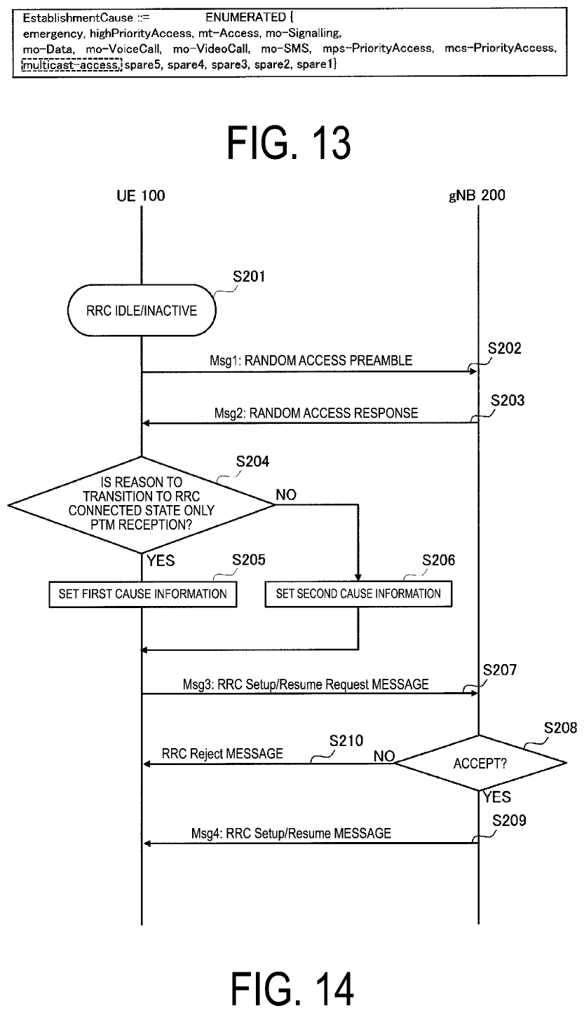

FIG. 13 is a diagram illustrating an example of cause information according to the second embodiment. Here, “EstablishmentCause IE”, which is cause information included in the RRC Setup Request message, is illustrated as an example, but the RRC Resume Request message may have a similar configuration.

“EstablishmentCause IE ” is configured to allow selection of “multicast-access”, which is an example of first cause information defined for MBS reception (PTM reception, multicast reception). When the reason (purpose) of transitioning to the RRC connected state is MBS reception (PTM reception, multicast reception), the UE 100 selects “multicast-access” and transmits, to the gNB 200, a connection request message in which “multicast-access” is set.

On the other hand, each of the following is an example of second cause information defined for unicast communication: “emergency”, “highPriorityAccess”, “mt-Access”, “mo-Signalling”, “mo-Data”, “mo-VoiceCall”, “mo-VideoCall”, “mo-SMS”, “mps-PriorityAccess”, and “mcs-PriorityAccess”. Details of the cause information are described in the 3GPP Technical

Specifications “TS38. 331”.

FIG. 14 is a diagram illustrating a first operation example according to the second embodiment. In the first operation example according to the second embodiment, the random access procedure is assumed to be a four-step random access procedure.

In Step S201, the UE 100 is in the RRC idle state or the RRC inactive state. Due to the presence of the reason (cause) for transitioning to the RRC connected state, the UE 100 starts the random access procedure to transition to the RRC connected state.

In Step S202, the UE 100 transmits a random access preamble (Msg1) to the gNB 200.

In Step S203, the gNB 200 transmits a random access response (Msg2) to the UE 100 in response to reception of the random access preamble (Msg1).

In Step S204, the UE 100 determines whether the reason to transition to the RRC connected state is only PTM reception (in particular, multicast reception).

When the reason to transition to the RRC connected state is only PTM reception (in particular, multicast reception) (Step S204: YES), in Step S205, the UE 100 sets, in the connection request message, the first cause information defined for PTM reception (in particular, multicast reception). The UE 100 may set the first cause information in the connection request message in response to satisfaction of any one of the following conditions, reception of a paging message (i.e., group activation notification) including the MBS session identifier for identifying the multicast session to be started, transition of the UE 100 to the RRC connected state only for the purpose of MBS reception, or transition of the UE 100 to the RRC connected state for the purpose other than uplink data transmission.

On the other hand, when the reason to transition to the RRC connected state includes both PTM reception and unicast communication (in particular, uplink data transmission) (Step S204: NO), in Step S206, the UE 100 sets, in the connection request message, second cause information defined for unicast communication.

In Step S207, the UE 100 transmits, to the gNB 200, the connection request message (RRC Setup Request message or RRC Resume Request message) in which the first cause information or the second cause information is set. In the four-step random access procedure, transmission of such a connection request message may be referred to as Msg3.

In Step S208, upon receiving the connection request message, the gNB 200 determines whether to accept the connection request from the UE 100, based on the cause information and the resource status included in the connection request message.

When the connection request from the UE 100 is accepted (Step S208: YES), in Step S209, the gNB 200 transmits an acknowledgment message (RRC Setup message or RRC Resume message) to the UE 100. As a result, the UE 100 transitions to the RRC connected state. In the four-step random access procedure, transmission of such an acknowledgment message may be referred to as Msg4.

On the other hand, when the connection request from the UE 100 is rejected (Step S208: NO), the gNB 200 transmits a negative acknowledgment message (RRC Reject message) to the UE 100 in Step S210. As a result, the UE 100 does not transition to the RRC connected state.

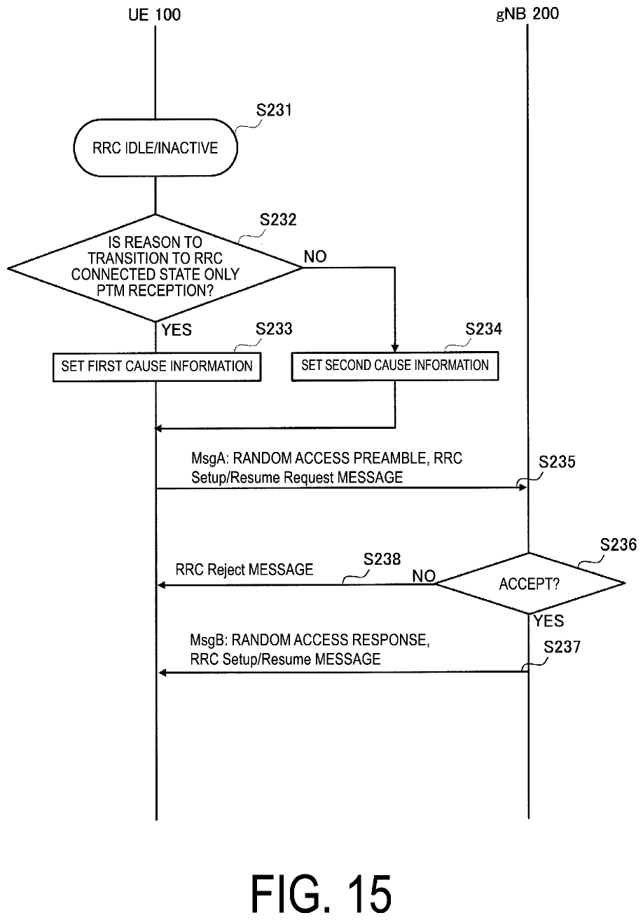

FIG. 15 is a diagram illustrating a second operation example according to the second embodiment. In the second operation example according to the second embodiment, the random access procedure is assumed to be a two-step random access procedure. Here, the difference from the first operation example of according to the second embodiment will be described.

In Step S231, the UE 100 is in the RRC idle state or the RRC inactive state. Due to the presence of the reason (cause) for transitioning to the RRC connected state, the UE 100 starts the random access procedure to transition to the RRC connected state.

In Step S232, the UE 100 determines whether the reason to transition to the RRC connected state is only PTM reception (in particular, multicast reception).

When the reason to transition to the RRC connected state is only PTM reception (in particular, multicast reception) (Step S232: YES), in Step S233, the UE 100 sets, in the connection request message, the first cause information defined for PTM reception (in particular, multicast reception).

On the other hand, when the reason to transition to the RRC connected state includes both PTM reception and unicast communication (in particular, uplink data transmission) (Step S232: NO), in Step S234, the UE 100 sets, in the connection request message, second cause information defined for unicast communication.

In Step S235, the UE 100 transmits, to the gNB 200 as MsgA, a set of the random access preamble and the connection request message (RRC Setup Request message or RRC Resume Request message) in which the first cause information or the second cause information is set.

In Step S236, upon receiving the connection request message, the gNB 200 determines whether to accept the connection request from the UE 100 based on the cause information and the resource status included in the connection request message.

When the connection request from the UE 100 is accepted (Step S236: YES), in Step S237, the gNB 200 transmits a set of the random access response and the acknowledgment message (RRC Setup message or RRC Resume message) to the UE 100 as MsgB. As a result, the UE 100 transitions to the RRC connected state.

On the other hand, when the connection request from the UE 100 is rejected (Step S236: NO), in Step S238, the gNB 200 transmits the negative acknowledgment message (RRC Reject message) to the UE 100 or transmits no random access response to the UE 100. As a result, the UE 100 does not transition to the RRC connected state.

### Other Embodiments

The operation flows described above can be separately and independently implemented, and also be implemented in combination of two or more of the operation flows. For example, some steps of one operation flow may be added to another operation flow or some steps of one operation flow may be replaced with some steps of another operation flow.

In the embodiments and examples described above, an example in which the base station is an NR base station (i.e., a gNB) is described; however, the base station may be an LTE base station (i.e., an eNB) or a 6G base station. The base station may be a relay node such as an Integrated Access and Backhaul (IAB) node. The base station may be a DU of the IAB node. The user equipment may be a Mobile Termination (MT) of the IAB node.

A program causing a computer to execute each of the processes performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 or the gNB 200 may be implemented as a semiconductor integrated circuit (chipset, system on a chip (SoC)).

Embodiments have been described above in detail with reference to the drawings, but specific configurations are not limited to those described above, and various design variation can be made without departing from the gist of the present disclosure.

The phrases “based on” and “depending on” used in the present disclosure do not mean “based only on” and “only depending on,” unless specifically stated otherwise. The phrase “based on” means both “based only on” and “based at least in part on”. Similarly, the phrase “depending on” means both “only depending on” and “at least partially depending on”. “Obtain” or “acquire” may mean to obtain information from stored information, may mean to obtain information from information received from another node, or may mean to obtain information by generating the information. The terms “include”, “comprise” and variations thereof do not mean “include only items stated” but instead mean “may include only items stated” or “may include not only the items stated but also other items”. The term “or” used in the present disclosure is not intended to be “exclusive or”. Further, any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

### Supplementary Note

### 1. Introduction

For the work item regarding NR Multicast and Broadcast Services (MBS), the following agreement has been reached on group notification:
The RAN2 waits for the final decision of the RAN1 as to which RNTI/DCI (Alt1, Alt2, etc. identified by the RAN1) to adopt for the MCCH modification notification.
No mechanism is defined to address the possibility that the UE misses the MCCH modification notification, and this is left with UE implementation.
As long as the RAN3 has conducted checks, paging for multicast activation notification is used for UEs with a disabled multicast session on associated legacy POs (paging occasions).
The RAN2 sends LS to the RAN3 and the SA2 to indicate, for UEs with inactive multicast sessions, the paging priorities of multicast activation notifications used on the associated legacy POs. The RAN2 requests the RAN3 to conduct checks, and if the RAN3 conducts checks, also defines the necessary network signaling.
The unicast paging message is enhanced and checked to confirm that the message contains a new paging record list for group activation notifications of multicast sessions.
The NAS is expected to inform the UE of the release of a multicast session.
Addressing scenarios from which the UE notification may be lost depends on network implementation (e.g., paging repetition).
The RAN2 does not prioritize handling of the PRACH bandwidth problem by group notification.
Further study is required for the usability of a short message or a WUS based indication for multicast activation notification of the corresponding paging message.
Introduction of MBS-specific UACs requires further study.
Further study is required for the cause of establishment of the MBS and the cause of resumption of the MBS.
Further study is required for the need to prioritize frequencies with multicast support for idle/inactive UEs monitoring multicast activation notifications.

This supplementary note discusses pending matters regarding the multicast activation notification of the first delivery mode (DM1) and the MCCH modification notification of the second delivery mode (DM2).

### 2. Discussion

### 2.1. Pending Matters (DM1) on Multicast Activation Notification

2.1.1. Short message and Wake-up Signal

The RAN2 has agreed on the following pending matters.
Further study is required for the usability of a short message or a WUS based indication for multicast activation notification of the corresponding paging message.

These mechanisms are discussed in the context of the impact of multicast activation notifications on legacy UEs or UEs not interested in the MBS.

The short message is transmitted on the PDCCH scrambled with the P-RNTI, and the bits of the DCI may indicate a change in system information (bit 1), an indication of ETWS and CMAS (bit 2), and termination of monitoring for paging (bit 3, NR-U only). In order to indicate that the paging message includes (only) the multicast activation notification, a new bit (e.g., bit 4) indicating the multicast activation notification may be used.

A reserved bit field ‘00’ of a short message indicator that is not the same as the foregoing short message may be used to indicate that the paging message includes only the multicast activation notification.

For the wakeup signal (WUS or PEI) on the table, the paging WUS may be used, and only the multicast activation notification may be included in the paging message for notification.

In general, legacy UEs cannot understand the reserved bits of the short message even when the reserved bits are defined in Rel-17. The legacy UE also cannot monitor the Rel-17 WUS. Accordingly, the legacy UE understands that decoding of the paging message cannot be avoided even when the new bit of the Short Message or the WUS indicates that the corresponding paging message includes only the multicast activation notification.

On the other hand, the proposal of using the short message indicator above may work for the legacy UE to avoid decoding of the paging message as long as the operation of the legacy UE is defined when the legacy UE receives the reserved bit field ‘00’ of the DCI. In other words, in this case, the legacy UE can avoid decoding the corresponding paging message. The concern is whether such legacy operation is already well-defined, that the operation consumes the last reserved bit field, and that in any case, the operation depends on the RAN1.

Observation 1: The legacy UE cannot understand the Rel-17 short message or monitor the Rel-17 WUS, and thus cannot avoid decoding the paging message. Observation 2: The legacy UE can avoid decoding the paging message when the operation of the legacy UE is cleared when the legacy UE receives the reserved bit field ‘00’ of the short message indicator.

The RAN2 has agreed that “as long as the RAN3 conducts checks, paging for the multicast activation notification is used on legacy POs associated with UEs with inactive multicast sessions”. From the UE point of view, this agreement is considered to be consistent with the RAN2 agreement “the use of paging on all (legacy) POs using the PRNTI is a basic assumption (other variations can still be discussed)”. In other words, both UEs interested in the MBS and UEs not interested in the MBS only wake up on the POs for unicast.

Observation 3: Rel-17 UEs only wake up on the legacy POs regardless of whether the UE waits only for the legacy unicast paging or the multicast activation notification.

Unnecessary paging reception occurs when a UE not interested in the MBS decodes a paging message containing only the multicast activation notification. However, the same problem occurs in Rel-15. In other words, the problem occurs when the UE decodes a paging message that does not page the UE. Accordingly, UE Power Saving Enhancements WI of Rel-17 is discussing paging subgroups and/or WUS. These two problems are caused by essentially the same underlying problem and may be solved by a single solution (e.g., paging subgroup/WUS).

Specifically, the CN is expected to assign a subgroup to UEs interested in the MBS and another subgroup to UEs not interested in the MBS. The CN can also assign different sub-groups for the respective TMGIs if necessary.

Observation 4: For the Rel-17 UE not interested in the MBS, with the paging subgroup and WUS discussed in the Rel-17 UE Power Saving Enhancements WI, for example, when the CN assigns two subgroups to each of the UE interested in the MBS and the UE not interested in the MBS, unnecessary paging reception can be avoided as is.

On the other hand, the UE not interested in the MBS does not decode the paging message upon receiving the DCI of the bit field “00”, and thus the proposal using the short message indicator is also effective.

Observation 5: The Rel-17 UE not interested in the MBS can avoid unnecessary paging reception by receiving the DCI in which the bit field of the short message indicator is “00”.

As described above, MBS-specific enhancements other than the short message indicator may be inefficient solutions.

The advantage of the enhanced short message indication is that the enhanced short message indication can address both the legacy UE and the Rel-17 UE, depending on the RAN1.

On the other hand, the disadvantages of the enhanced short message indication are that the enhanced short message is an MBS-specific solution, the operation of the legacy UE is not well-defined, and the last reserved bit field is consumed.

The advantage of the paging subgroup/WUS is that the paging subgroup/WUS can be a unified solution for both unicast paging and multicast activation notification. However, the disadvantage of the paging subgroup/WUS is that the paging subgroup/WUS does not work for the legacy UE.

Email discussions reveal that the multicast activation notification may not be frequently used and that the UE power consumption due to the multicast activation notification may ultimately not be a significant problem.

Proposal 1: The RAN2 should agree to pursue only the enhancement of the short message indicator, rather than the enhancement of the short message.

Proposal 2: The RAN2 should discuss whether to apply the Rel-17 paging subgroup/WUS as is (working only in Rel-17 UEs, no MBS optimization) or enhance the short message indicator (working also in legacy UEs, up to the RAN1).

### 2.1.2. Unified Access Control

The RAN2 has agreed on the following pending matters.
Introduction of MBS-specific UACs requires further study.

The UAC procedure confirms access barring according to Access Category (AC) and Access Identity (AI) provided by upper layers or the RRC itself, and is performed at the beginning of an RRC connection establishment procedure and an RRC connection resumption procedure. When the UE judges, as a result of the UAC procedure, that an access attempt is prohibited, the UE refrains from transmitting the RRC Setup Request or the RRC Resume Request and does not start a RACH procedure. The UAC is used during network congestion, especially PRACH congestion. As a result, the UAC can ensure accessibility to emergency calls and the like even in a congested state.

For the congestion of the PRACH due to the multicast activation notification, the RAN2 has agreed that “the RAN2 does not give priority to the handling of the PRACH bandwidth problem due to the group notification”. Thus, in Rel-17 deployments, congestion due to the multicast activation may be interpreted not to be a significant problem. In this case, high-priority accesses (such as emergency calls) are not affected by the MBS service. Therefore, the UAC enhancements discussed in the email discussions are not necessary.

Observation 6: according to the RAN2 agreement that the PRACH bandwidth issue is not prioritized, the network congestion due to the multicast activation notifications is not a significant problem in Rel-17 deployments.

Observation 7: As a result of Observation 6, access to high priority services such as emergency calls is not affected by the multicast activation notification.

Proposal 3: The RAN2 should agree not to pursue UAC enhancements.

### 2.1.3. Cause of Establishment/Resumption

The RAN2 has agreed on the following pending matters.
Further study is required for the cause of establishment of the MBS and the cause of resumption of the MBS.

The cause of establishment and the cause of resumption are notified from the UE by information from upper layers or by the RRC itself in the RRC Setup Request and the RRC Resume Request, respectively. The gNB may determine whether to accept or reject a request from the UE in consideration of the usage of radio resources, hardware loads, backhaul/TNL quality, and the like. Due to access from a UE providing a high-priority service, the gNB may determine to release the RRC connection of another UE. The cause of establishment/resumption may seem similar to the UAC, but is actually a different mechanism for a different purpose.

The possibility of enhancement of the cause of establishment/resumption is also being discussed. The multicast activation notification is a kind of paging, and thus reusing the existing mt-Access has also been proposed.

In particular, provision of MBS sessions via PTM is understood to consume less resources than the use of unicast connection. Therefore, even when the network is congested, there is no reason for the gNB to reject a connection request for an MBS service.

Observation 8: MBS services consume much less resources than unicast services (especially when the MBS session is provided via PTM).

It is assumed that some gNB implementations always accept requests made by mt-Access while other gNB implementations reject requests depending on the congestion/overload of the gNB. In this case, for reuse of the existing mt-Access, a problem is such that the gNB cannot distinguish between an MBS reception request and a unicast connection request. Therefore, defining a new cause value is effective, the cause value indicating that the connection request is intended only for MBS reception.

Observation 9: The existing mt-Access prevents distinction between the connection request for MBS reception and the connection request for unicast communication, leading to possibly degraded user experience and resource efficiency.

Proposal 4: The RAN2 should agree to introduce a new cause of establishment/resumption, i.e. only the multicast reception.

### 2.1.4. Cell Reselection

The RAN2 has agreed on the following pending matters.
Further study is required for the need to prioritize frequencies with multicast support for idle/inactive UEs monitoring multicast activation notifications.

The RAN2 has agreed that, at non-supporting nodes, the MBS session ID does not work because the use of the MBS session ID affects non-MBS nodes. The unicast paging works at non-supporting nodes, and thus UEs in a cell not supporting the MBS can ultimately receive legacy paging upon activation of a multicast session. However, the problem is found to be related to paging capacity/efficiency rather than to whether the UE can be paged upon activation of a multicast session.

The motivation for introducing the multicast activation notification (group paging) is to reduce the number of legacy pages (dedicated UE pages). Accordingly, an increase in the number of UEs that cannot receive a multicast session due to a cell not supporting the MBS directly leads to an increase in the number of legacy pages, which affects the legacy UEs and the UEs not interested in the MBS due to insufficient paging capacity.

In the implementation of the AMF for the paging strategy, the AMF can be considered to initially start only the multicast activation notification. When any UEs are nonresponsive, i.e., any UEs are in the idle/inactive state, the AMF starts individual legacy paging of these UEs to minimize dedicated paging.

Accordingly, how many UEs are in a cell supporting the MBS is important. Therefore, the UE needs to prioritize the cell supporting the MBS while waiting for the multicast activation notification.

Observation 10: The number of legacy (dedicated) pages increases directly consistently with the number of UEs missing the multicast activation notification. This affects the legacy UEs and the UEs not interested in the MBS due to insufficient paging capacity.

The RAN2 has agreed that for the second delivery mode, “the UE is allowed to prioritize MBS frequencies of interest as LTE SC-PTM when the cells of the MBS frequencies provide MBS SIBs carrying the MCCH configuration”. “For LTE SC-PTM, the UE is allowed to prioritize the MBS frequency of interest when the UE can receive the MBS service only by camping on the MBS frequency” and “For LTE SC-PTM, the UE may consider the cell reselection candidate frequency at which the MBS service cannot be received to have the lowest priority during the MBS session”. Accordingly, common UE operation can be enabled in both the first delivery mode and the second delivery mode.

Observation 11: The UE operation in the idle/inactive mode is desirably the same in both broadcast (second delivery mode) and multicast (first delivery mode).

As described above, the UE in the idle/inactive state needs to preferentially use frequencies supporting multicast in order to maximize the possibility of receiving the multicast activation notification.

Proposal 5: The RAN2 should agree that UE in the idle/inactive state monitoring the multicast activation notification prioritizes the frequencies supporting multicast.

### 2.2. MCCH Modification Notification Related to Other Information (DM2)

The RAN2 has agreed to introduce an MCCH modification notification provided due to session start, session change, and session termination. This indicates the current intention that the MCCH modification notification is transmitted when a configuration for MTCH reception such as MBS session information and MTCH scheduling information is modified. The RAN2 has agreed on the following pending matters.
An indication of an MCCH modification due to a modification in the configuration of an ongoing session (including session termination) is provided in an explicit notification from a network (on the condition that the RAN1 confirms that the MCCH modification notification DCI can accommodate, in addition to a bit for a session start notification, another bit for this purpose). Further study is required to determine whether this notification can be reused to modify other information transmitted by the MCCH.

“Other information” may be interpreted as follows: “for LTE SC-PTM, whether the gNB can indicate a list of neighboring cells providing a broadcast MBS service provided by the current cell is FS”. If the UE misses a neighboring cell/frequency information, this is not a significant problem when the UE stays in the serving cell. However, for the UE in the idle/inactive state, the latest neighboring cell information is important in the case of inter-cell mobility. Accordingly, for continuation of more reliable services, when the RAN2 agrees that the MCCH provides the neighboring cell/frequency information, the MCCH modification notification needs to be transmitted even when other information is modified.

Proposal 6: The RAN2 should agree that the MCCH modification notification is transmitted when any of the MCCH contents is modified, in other words, the RAN2 should agree applicability to “other information” including at least the neighboring cell information (if the RAN2 agrees that the MCCH provides the neighboring cell information) in addition to the MBS session information and the MTCH scheduling information.

### REFERENCE SIGNS

1: Mobile communication system
10: RAN
20: CN
100: UE
110: Receiver
120: Transmitter
130: Controller
200: gNB
210: Transmitter
220: Receiver
230: Controller
240: Backhaul communicator

1. A communication method used in a mobile communication system for providing a multicast/broadcast service (MBS), the communication method comprising:
transmitting, by a first network node, a paging message to a second network node over an inter-network node interface, the paging message requesting paging of a user equipment having joined a multicast session and comprising an MBS session identifier identifying the multicast session;
receiving, by the second network node, the paging message from the first network node; and
transmitting, from the second network node to the first network node, a message in response to the second network node receiving an access from the user equipment, the message indicating that the user equipment has accessed to the second network node.

2. The communication method according to claim 1, wherein the MBS session identifier in the paging message comprises a Temporary Mobile Group Identity (TMGI).

3. The communication method according to claim 1, wherein
the second network node transmits a RETRIEVE UE CONTEXT REQUEST message for obtaining context information of the user equipment, as the message.

4. The communication method according to claim 1, further comprising:
transmitting, by a paging entity, a first paging message comprising an MBS session identifier identifying a multicast session to be started, the paging entity generating a paging message used to page a user equipment in a radio resource control (RRC) idle state or an RRC inactive state;
identifying, by the paging entity, a user equipment having joined the multicast session and having not responded to the first paging message; and
transmitting, by the paging entity, a second paging message comprising a user equipment identifier identifying the identified user equipment.

5. The communication method according to claim 4, wherein the transmitting of the second paging message comprises transmitting the second paging message only when a user equipment having joined the multicast session and having not responded to the first paging message is present.

6. The communication method according to claim 4, wherein the paging entity is an Access and Mobility Management Function (AMF).

7. The communication method according to claim 4, wherein the paging entity is a base station.

8. The communication method according to claim 1, further comprising:
setting, by a user equipment in a radio resource control (RRC) idle state or an RRC inactive state, cause information indicating a reason to transition to an RRC connected state in an RRC message used to transition to the RRC connected state; and
transmitting, by the user equipment, the RRC message to a network node,
wherein the setting comprises:
setting first cause information defined for MBS reception in the RRC message as the cause information when the reason is only multicast or broadcast reception of an MBS; and
setting second cause information defined for unicast communication in the RRC message as the cause information when the reason is both the multicast or broadcast reception and the unicast communication.

9. The communication method according to claim 8, wherein
the setting of the first cause information in the RRC message comprises setting the first cause information in the RRC message in response to any one of:
receiving, by the user equipment, a paging message comprising an MBS session identifier identifying a multicast session to be started;
transitioning, by the user equipment, to the RRC connected state for a purpose of only the MBS reception; and
transitioning, by the user equipment, to the RRC connected state for a purpose other than uplink data transmission.

10. The communication method according to claim 8, wherein the RRC message is an RRC Setup Request message.

11. The communication method according to claim 8, wherein the RRC message is an RRC Resume Request message.

12. A network node used in a mobile communication system for providing a multicast/broadcast service (MBS), the network node comprising:
a receiver configured to receive, from a different network node, a paging message over an inter-network node interface, the paging message requesting paging of a user equipment having joined a multicast session and comprising an MBS session identifier identifying the multicast session; and
a transmitter configured to transmit, to the different network node, a message in response to receiving an access from the user equipment, the message indicating that the user equipment has accessed to the network node.

13. A processor for a network node used in a mobile communication system for providing a multicast/broadcast service (MBS), the processor comprising:
a receiver circuitry configured to receive, from a different network node, a paging message over an inter-network node interface, the paging message requesting paging of a user equipment having joined a multicast session and comprising an MBS session identifier identifying the multicast session; and
a transmitter circuitry configured to transmit, to the different network node, a message in response to receiving an access from the user equipment, the message indicating that the user equipment has accessed to the network node.

14. A non-transitory computer readable medium that stores computer program comprising instructions that, when the computer program is executed by a network node, cause the network node to carry out:
receiving, from a different network node, a paging message over an inter-network node interface, the paging message requesting paging of a user equipment having joined a multicast session and comprising an MBS session identifier identifying the multicast session; and
transmitting, to the different network node, a message in response to receiving an access from the user equipment, the message indicating that the user equipment has accessed to the network node.

15. A mobile communication system comprising: the network node according to claim 12; and a user equipment.
